(19) United States
(12) Patent Application Publication
(10) Pub. No.: US 2026/0038703 A1
(43) Pub. Date: Feb. 5, 2026

(54) COMPONENT FOR EXPOSING FLUID TO AN INPUT SHOCKWAVE

(71) Applicant: FIRST LIGHT FUSION LIMITED, Yarnton, Oxfordshire (GB)

(72) Inventors: Peter Allan, Yarnton, Oxfordshire (GB); Matthew Betney, Yarnton, Oxfordshire (GB); Hugo Doyle, Yarnton, Oxfordshire (GB); Oliver Hall, Yarnton, Oxfordshire (GB); Jonathan Skidmore, Yarnton, Oxfordshire (GB)

(21) Appl. No.: 19/099,773

(22) PCT Filed: Jul. 27, 2023
(86) PCT No.: PCT/GB2023/051999

§ 371 Date: Jan. 29, 2025

(30) Foreign Application Priority Data
Aug. 5, 2022 (GB) 2211491.2

(51) Int. Cl. G21B 3/00

(52) U.S. Cl. CPC G21B 3/008; G21B 3/006

(57) ABSTRACT

A component for exposing fluid to an input shockwave includes a body defining an input face arranged to receive the input shockwave, a chamber recessed in the input face for containing fluid, a fluid inlet for introducing fluid into the component, and an intermediate volume defined in the input face. The intermediate volume is provided at least partially between the fluid inlet and the chamber. The intermediate volume is fluidly connected to the fluid inlet and to the chamber for supplying fluid from the fluid inlet to the chamber. A portion of the input face is configured to sealingly abut against a further element for enclosing the intermediate volume .

### CROSS-REFERENCE TO RELATED APPLICATIONS

This application is a 35 U.S.C. § 371 national phase filing of International Application No. PCT/GB2023/051999 filed on Jul. 27, 2023, and claims the benefit of United Kingdom Patent Application No. 2211491.2 filed on Aug. 5, 2022, wherein the entire disclosures of the foregoing applications are hereby incorporated by reference herein.

### TECHNICAL FIELD

This invention relates to a component for exposing fluid to an input shockwave, in particular to a component to be used in methods and systems for producing high localized concentrations of energy.

### BACKGROUND

It has been shown in WO 2011/138622 that an interaction between a shockwave in a non-gaseous medium and a gaseous medium can generate a high speed transverse jet of the non-gaseous medium that moves through the gaseous medium. This results in the jet impacting on and trapping a volume of the gaseous medium, e.g. against a target, which gives rise to an intense concentration of energy within the gas.

To supply the gaseous medium (e.g. fuel) for the target, one option is to use a fill tube to input the gaseous medium into the target. However, this fill tube causes unwanted instabilities that can cause the gaseous medium to collapse in an undesired way, which reduces the performance of the apparatus. Solutions such as reducing the diameter of the fill tube, angling the fill tube and blocking the fill tube with glue have been proposed. However, such solutions do not fully solve the problem, as they make it more difficult to operate the apparatus and can still lead to instabilities.

The present invention aims to provide a system and a component which addresses these problems more effectively.

### Summary

When viewed from a first aspect, the invention provides a component for exposing fluid to an input shockwave, the component comprising:
a body defining:
   an input face arranged to receive the input shockwave;
   a chamber recessed in the input face for containing fluid;
   a fluid inlet for introducing fluid into the component; and
   an intermediate volume defined in the input face;
      wherein the intermediate volume is provided at least partially between the fluid inlet and the chamber;
      wherein the intermediate volume is fluidly connected to the fluid inlet and to the chamber for supplying fluid from the fluid inlet to the chamber; and
      wherein a portion of the input face is configured to sealingly abut against a further element for enclosing the intermediate volume.

The invention thus provides a component that is able to hold (e.g. contain) fluid (e.g. liquid and/or gas), such that the fluid can be exposed to an input shockwave. The input face (e.g. at least a portion of the input face, such as a portion of the input face surrounding (e.g. fully surrounding) the intermediate volume) is configured to sealingly (e.g. form a fluid tight seal such as a liquid tight seal and/or a gas tight seal) abut against a further element, so to enclose the intermediate volume, preventing escape of the fluid. For example, the component may be configured to hold the fluid in the chamber such that the fluid can be exposed to a high pressure shockwave, leading to a collapse of the fluid and a concentration of energy within the fluid.

Thus it will be seen that, using a component in accordance with the invention, the fluid (which may comprise a fuel) may be supplied to the chamber (e.g. a target cavity) without an input tube needing to run directly into the chamber where the shockwave will be incident upon the fluid. As such, the dynamics of the shockwave's interaction with the component and the fluid therein are not affected by an inlet tube. This helps to control the progression of the shockwave in the chamber.

In embodiments, the body defines a fluid outlet for outputting fluid from the component. The fluid outlet is fluidly connected to the intermediate volume, e.g. so that fluid may be output from the chamber to the fluid outlet via the intermediate volume. The fluid outlet may be used to determine whether fluid has reached the intermediate volume, e.g. to confirm that the fluid inlet is not blocked. Thus, in embodiments, the component comprises a sensor arranged to detect the presence (e.g. flow) of fluid in or from the fluid outlet.

The fluid outlet may be located such that the chamber is located at least partially between the fluid inlet and the fluid outlet. This may help to confirm that fluid has not only reached the intermediate volume, but also has reached the chamber. For example, the fluid inlet, the intermediate volume, the chamber and the fluid outlet may be defined in the body such that the fluid passes from the fluid inlet to the intermediate volume, then to the chamber, then to (e.g. a different portion of) the intermediate volume, and finally to the fluid outlet.

The fluid inlet and the fluid outlet (when provided) may be defined in the body in any suitable and desired way. In embodiments, the fluid inlet and/or the fluid outlet comprises a channel or bore through the body, e.g. from one (e.g. an opposite) side of the body (through the body) to the intermediate volume. Thus, the fluid inlet and/or the fluid outlet may extend in a direction that is out of plane (e.g. non-parallel) to the input face.

In embodiments, the component (or a system of which the component comprises a part) comprises a fluid supply connected to the fluid inlet, wherein the fluid supply is arranged to supply fluid into the fluid inlet (e.g. for supplying fluid to the intermediate volume and/or chamber). In embodiments, the component (or a system of which the component comprises a part) comprises a pressure or flow sensor connected to the fluid outlet, wherein the pressure or flow sensor is arranged to detect the presence of fluid at the fluid outlet (and thus in the intermediate volume and/or chamber).

The (e.g. body of the) component may be arranged to be used with any suitable and desired fuel. In embodiments, the fluid comprises a fuel, e.g. a fuel for nuclear fusion. In embodiments the fluid comprises hydrogen, deuterium and/or tritium in liquid and/or gaseous form.

The intermediate volume may have any suitable and desired geometry. The intermediate volume is defined by the input face and the further element (e.g. between the input face and a face of the further element that sealingly abuts against the input face). In embodiments, the intermediate volume is recessed in the input face. In embodiments, (at least part of) the input face is spaced from (at least part of) the (face of the) further element (so as to define the intermediate volume). In embodiments, the intermediate volume at least partially (e.g. fully) surrounds the chamber. In embodiments, the intermediate volume has a prismatic (e.g. cylindrical) shape, e.g. with the axis along which the prism or cylinder extends (and the axis about which the intermediate volume is rotationally symmetric) being substantially perpendicular to the (e.g. plane of the) input face.

In embodiments, the intermediate volume is a squat prism (e.g. cylinder), having a depth (the dimension in the direction parallel to the axis along which the prism or cylinder extends) that is (e.g. significantly) less than the dimension of the prism (e.g. diameter of the cylinder) in a direction perpendicular to the axis along which the prism or cylinder extends.

In embodiments, the chamber is located substantially at the centre of the intermediate volume. For example, the chamber may be defined as a deeper recess in the input face, e.g. at least partially (e.g. fully) within or surrounded by the intermediate volume.

The chamber may have any suitable and desired geometry. In embodiments, the chamber is conical. The conical shape may help to direct the shockwave into the apex of the cone, enhancing the pressure achieved in the fluid.

In embodiments, the axis of the chamber (e.g. around which the chamber is rotationally symmetric) is substantially perpendicular to the (e.g. plane of the) input face. In embodiments, the axis of the chamber is coaxial with the axis of the intermediate volume. In embodiments the base (e.g. apex) of the chamber is distal from the input face, e.g. the maximum cross sectional area of the chamber is proximal to the input face.

The chamber may be defined by the body in any suitable and desired way. For example, the body may comprise a unitary body in which the fluid inlet (and, e.g. fluid outlet), the intermediate volume and the chamber are defined. In embodiments, however, the body comprises a plug (e.g. insert), wherein the plug defines the chamber. Thus the plug may be located in (e.g. at least partially received within) the other material (e.g. bulk) of the body. Providing a plug may allow it to be individually configured, e.g. to provide a chamber having a particular geometry, or allow it to be made from a different material, independently from the rest of the body.

The plug may have any suitable and desired geometry. In embodiments, the plug has a prismatic (e.g. cylindrical) outer shape, e.g. having an axis along which the prism or cylinder extends that is substantially perpendicular to the (e.g. plane of the) input face, e.g. substantially parallel (e.g. coaxial with) the axis of the intermediate volume. In embodiments, the face of the plug (e.g. proximal to the input face) is flush with the (e.g. surface of the) intermediate volume.

In embodiments, the plug is formed from (comprises, e.g. consists of) a material having a density that is greater than the other material (e.g. bulk) of the body. In embodiments, the plug is formed from (comprises, e.g. consists of) a (e.g. soft) metal, e.g. gold.

The input face may have any suitable and desired geometry. For example, the (e.g. portion of the input face in which the intermediate volume and the chamber are not formed) may be substantially planar.

In embodiments, the input face comprises an outer (e.g. annular) rim, e.g. that is substantially planar. In embodiments, the intermediate volume is recessed (e.g. stepped) in from the outer (e.g. annular) rim of the input face. In embodiments, the outer (e.g. annular) rim at least partially (e.g. fully) surrounds the intermediate volume.

At least a portion (e.g. the outer rim) of the input face is configured to sealingly abut against a further element, to enclose the intermediate volume (and, e.g., the chamber). The further element may be any suitable and desired element of a system in which the component is to be used.

In embodiments, (e.g. at least a portion of) the input face is configured to sealingly abut (e.g. contact such that a fluid seal is formed, such as a liquid seal and/or a gas seal) against a shockwave modulating element (e.g. an element configured to manipulate an input shockwave).

In embodiments, (e.g. at least a portion of) the input face is configured to sealingly abut against a cover. Thus, in embodiments, the component comprises the further element (e.g. the cover); wherein the intermediate volume (and, e.g., the chamber) is sealed (e.g. closed) by the further element (e.g. the cover), e.g. such that the only fluid path into (and, e.g., out of) the intermediate volume and the chamber is the fluid inlet (and, e.g., fluid outlet).

In embodiments, the input face forms a fluid tight seal with the further element, e.g. in embodiments in which the component comprises the further element.

In embodiments, the further element (e.g. the cover) is at least partially affixed to the body by an adhesive, e.g. applied proximal to the periphery of the intermediate volume. In embodiments, the further element (e.g. the cover) and the body may be clamped or fastened together.

In embodiments, the body defines one or more channels in the intermediate volume. Preferably the one or more channels are configured to substantially prevent excess adhesive from reaching the chamber and/or the fluid inlet and/or the fluid outlet, e.g. the channels are arranged to collect excess adhesive.

In embodiments, the fluid inlet (and, e.g., the fluid outlet) is located between the chamber and the one or more channels. In embodiments, the one or more channels are radially outward of the chamber and, e.g., of the fluid inlet (and, e.g., the fluid outlet), e.g. proximal to the periphery of the intermediate volume, e.g. between the periphery of the intermediate volume and one or more (e.g. all) of the chamber, the fluid inlet and the fluid outlet. In embodiments, the one or more channels comprises an annular groove in the intermediate volume, e.g. recessed in the intermediate volume further from the input face of the body.

The body may be formed from any suitable and desired material, e.g. that is easily moulded or machined. In embodiments, the body is at least partially formed from (comprises, e.g. consists of) a plastic. In embodiments, the body is formed from (comprises, e.g. consists of) a metal (such as steel), e.g. a light metal (such as aluminium).

The body may have any suitable and desired dimensions. In one embodiment the body has a maximum dimension between 1 mm and 200 mm, e.g. between 5 mm and 100 mm, e.g. between 10 mm and 50 mm, e.g. approximately 30 mm. The chamber may have any suitable and desired dimensions. In one embodiment the chamber has a depth, diameter and/or maximum dimension between 0.1 mm and 100 mm, e.g. between 1 mm and 50 mm, e.g. between 2 mm and 10 mm, e.g. approximately 3 mm, 5 mm or 8 mm. In one embodiment the intermediate volume has a depth (the dimension in the direction perpendicular to the input face) between 10 microns and 1 mm, e.g. between 20 microns and 500 microns, e.g. between 50 microns and 100 microns.

Providing the further element as part of the component is considered to be novel and inventive in its own right and thus, when viewed from a further aspect, the invention provides a component for exposing fluid to an input shockwave, the component comprising:
an element configured to receive the input shockwave and allow the shockwave to propagate through the element; and
a body defining:
   an input face arranged to at least partially receive the shockwave after it has propagated through the element;
   a chamber defined in the input face for containing fluid;
   a fluid inlet for introducing fluid into the component; and
   an intermediate volume defined in the input face;
      wherein the intermediate volume is provided at least partially between the fluid inlet and the chamber;
      wherein the intermediate volume is fluidly connected to the fluid inlet and to the chamber for supplying fluid from the fluid inlet to the chamber; and
      wherein the input face is configured to sealingly abut against the element such that the intermediate volume is enclosed by the element.

Thus, the intermediate volume is defined by (e.g. a recess in) the input face and the element that receives the input shockwave. It will be appreciated that this aspect may (and preferably does) include one or more (e.g. all) of the preferred and optional features disclosed herein, e.g. relating to other aspects and embodiments of the invention, as applicable.

The component may be arranged such that the element receives all of the input shockwave, e.g. such that the body only receives the shockwave after it has propagated through the element. Alternatively, the component may be arranged such that the element receives part (e.g. the majority) of the input shockwave and (e.g. part of) the body receives part (e.g. the remainder) of the input shockwave, e.g. such that part of the body receives the shockwave after it has propagated through the element.

In embodiments, the element comprises a shockwave modulating element, wherein the shockwave modulating element is arranged to receive an input shockwave and manipulate the input shockwave so to produce a manipulated shockwave, e.g. for being incident upon the input face after it has propagated through the shockwave modulating element.

The shockwave modulating element may be arranged to modulate the input shockwave in any suitable and desired way, e.g. modify the shape and/or intensity of the input shockwave. In embodiments, the element comprises a shockwave amplifying element, wherein the shockwave modulating element is arranged to amplify (e.g. concentrate the intensity of) the input shockwave.

In embodiments, the (e.g. shockwave modulating or amplifying) element comprises:
an element body comprising a first material;
   wherein the element body defines a cavity for manipulating the input shockwave so to produce a manipulated shockwave;
      wherein the cavity comprises:
         an input for receiving the input shockwave incident upon the component; and
         an output for outputting the manipulated shockwave from the cavity; and
   wherein the cavity contains a second material having a shock-impedance that is lower than a shock-impedance of the first material.

The element has a body that is shaped to define a cavity. The cavity has an input (e.g. aperture) designed to receive the (input) shockwave that is incident upon the input of the cavity. The cavity is designed (e.g. shaped) to manipulate the shockwave as it passes through the cavity. The cavity also has an output (e.g. aperture) designed to output the manipulated shockwave.

The element body may have any suitable and desired dimensions and the dimensions will be determined by the specific application of the element. In one embodiment the (e.g. cavity of the) element body has a thickness, diameter and/or maximum dimension between 0.1 mm and 100 mm, e.g. between 1 mm and 50 mm, e.g. between 2 mm and 10 mm, e.g. approximately 3 mm, 5 mm or 8 mm.

The body is formed from (comprises, e.g. consists of) a first material. The cavity contains (e.g. is at least partially filled with) a second material. The second material has a shock-impedance that is lower than a shock-impedance of the first material. Thus the (shape of the) cavity is defined by the (e.g. internal walls of the) body (formed from the first material) and the second material is located within the volume of the cavity.

Thus it will be seen that the element can be used to manipulate (e.g. modify the shape and/or intensity of) an input shockwave, owing to the (e.g. shape of the) cavity and the difference in shock-impedance of the first and second materials. As such, the shockwave transmitted from the output of the cavity may have a greater (e.g. energy) intensity than the input shockwave received at the input of the cavity.

Furthermore, the element may help to manipulate the input shockwave in a way that helps to prevent or delay the jetting of material that is experienced with the apparatus and method disclosed in WO 2011/138622, e.g. owing to the shape of the cavity and/or the presence of the second material within the cavity. This may help to amplify (e.g. concentrate the intensity of) the input shockwave, e.g. before it is used to cause an impact against a target, thus helping to increase the concentration of energy generated by the impact.

The body may comprise (e.g. (internal) walls having) any suitable and desired shape to define the cavity.

In embodiments, the body (and thus the cavity) is shaped such that the input has a cross sectional area that is greater than the (e.g. corresponding) cross sectional area of the output. The cross sectional area of the input and/or the output may be defined in a plane substantially perpendicular to a direction between the input and the output, e.g. such that the cross sectional area of the input is substantially parallel to the cross sectional area of the output. The direction between the input and the output may be substantially parallel to the direction in which the input shockwave is arranged to be propagated to be incident upon the component (e.g. in embodiments of the invention).

In embodiments, the (e.g. a section of the) cavity comprises a frustum, e.g. the body is shaped to define a frustum-shaped cavity. Thus preferably a cross section of the cavity (e.g. in a plane parallel to the direction between the input and the output) comprises straight sides (walls) and, e.g., the cross-section is symmetrical (in that plane).

The frustum may comprise any suitable and desired type of frustum. In embodiments, the cavity comprises a conic frustum. Thus preferably the cavity is rotationally symmetric about an axis through the cavity. Preferably the axis of the body or cavity is parallel to the direction between the input and the output.

In embodiments, the (cross section and/or walls of the) cavity comprises two or more sections (e.g. sub-cavities) that are at different respective angles to the axis of the cavity (e.g. the axis about which the cavity is rotationally symmetric, e.g. parallel to the direction between the input and the output). Thus, for example, the cavity may comprise two or more frustums, wherein the two or more frustums have side walls having different respective angles to the axis of the cavity. Providing different angles for the cavity sections may help to manipulate the input shockwave in a particular manner, e.g. to accelerate the input shockwave from the input to the output.

In embodiments in which the cavity has three or more frustum sections, each section may be at a different angle to each of the other sections; however, two or more of the sections may be at the same angle, with one or more intermediate sections of the cavity at a different angle.

In embodiments, instead of or in addition to the cavity having one or more straight-sided sections (in cross section), the cavity may have a cross section having one or more sections having curved walls. For example, the cavity may comprise a flared (e.g. conic) frustum wherein the cavity walls are (e.g. elliptically) curved. These types of shapes may help to provide greater uniformity of the shock front and of the shock shape at the output.

In embodiments, the element comprises an input impedance matching layer. The impedance matching layer may comprise a layer of material provided between two other materials, wherein the impedance matching layer is formed from a material which has a shock-impedance which is between the shock-impedance of the two materials. For example, a layer of aluminium may be provided between layers of tantalum and copper. In embodiments, impedance matching layers may comprise a plurality of materials which are arranged in layers such that the shock-impedance changes incrementally between layers.

Impedance matching layers help to couple energy between different layers of material.

In embodiments, the element comprises an input impedance matching layer adjacent to (e.g. extending across) the (e.g. aperture of the) input of the cavity. The impedance matching layer helps to improve the transmittal of energy (e.g. from an incident projectile) into the second material, by helping to reduce the reflected element of the input shockwave, e.g. from the surface of the second material. Thus the input impedance matching layer may help to couple the input shockwave into the cavity.

In embodiments, the input impedance matching layer comprises a planar layer. The input impedance matching layer may comprise (e.g. consists of) a material having a shock-impedance that is greater than the shock-impedance of the second material, e.g. having a shock-impedance that is less than the first material, e.g. having a shock-impedance between the shock-impedance of the first material and the shock-impedance of the second material.

In embodiments, the shock-impedance of the input impedance matching layer is between the shock-impedance of (the material of) an impacting projectile configured to generate the input shockwave (e.g. when impacting on the element) and the material of the second material.

In embodiments, the element comprises an output impedance matching layer adjacent to (e.g. extending across) the (e.g. aperture of the) output of the cavity. The impedance matching layer helps to improve the transmittal of energy from the (e.g. second material of the) cavity, by helping to reduce the reflected element of the shockwave as the shockwave is output from the cavity, e.g. from the output surface of the second material. Thus the output impedance matching layer may help to couple the shockwave out of the cavity.

In embodiments, the output impedance matching layer comprises a planar layer. The output impedance matching layer may comprise (e.g. consists of) a material having a shock-impedance that is less than the shock-impedance of the second material, e.g. having a shock-impedance that is greater than a (e.g. target) material upon which the output shockwave is to be incident, e.g. having a shock-impedance between the shock-impedance of the second material and the shock-impedance of a (e.g. target) material upon which the output shockwave is to be incident.

When viewed from a further aspect, the invention provides a method of manipulating a shockwave, the method comprising generating at least one shockwave to be incident upon (e.g. the element of) a component according any one of the aspects or embodiments described herein.

It will be appreciated that this aspect may (and preferably does) include one or more (e.g. all) of the preferred and optional features disclosed herein, e.g. relating to other aspects and embodiments of the invention, as applicable.

In embodiments, the method comprises driving a projectile into the (e.g. element of the) component to generate the at least one shockwave.

When viewed from a further aspect, the invention provides a system for producing a localised concentration of energy comprising:
a component according any one of the aspects or embodiments described herein; and
a mechanism for generating a shockwave to be incident upon the (e.g. element of the) component.

It will be appreciated that this aspect may (and preferably does) include one or more (e.g. all) of the preferred and optional features disclosed herein, e.g. relating to other aspects and embodiments of the invention, as applicable.

It will be understood that where used herein, the term “shock-impedance” is intended to mean “the pressure which must be applied to a medium in order to impart a unit particle velocity to some of the medium” (Henderson, ‘On the refraction of shock waves’, Journal of Fluid Mechanics, Volume 198, January 1989, pages 365-386). This is equal to the product of the shock speed and the density of the un-shocked material.

It will be understood that the input shockwave may be formed outside of the (e.g. element of the) component and propagate into the component, but may additionally or alternatively be generated in the component, for example by the (e.g. element of the) component being struck (e.g. by a projectile). Both alternatives are covered by the wording “input shockwave”.

Embodiments of the component may be suitable for exposing fluid to an input shockwave to generate localised energy concentrations, e.g. for the purpose of generating conditions suitable for nuclear fusion in the chamber (e.g. a target). However, the system is not limited to this, and may be used for other applications in which the chamber contains a (e.g. different type of) fluid. For example, the (e.g. chamber of the) component may be configured to contain fluid (e.g. gaseous) reactants. The component may be arranged to expose the reactants to the shockwave to place them under pressure, e.g. in order to increase the rate of reaction.

### BRIEF DESCRIPTION OF DRAWINGS

Certain embodiments of the invention will now be described, by way of example only, with reference to the accompanying drawings, in which:

FIG. 1 shows a schematic cross sectional view of a system in accordance with an embodiment of the invention;

FIG. 2 shows a schematic perspective cutaway view of the component from the system of FIG. 1;

FIG. 3 shows a cross sectional view of the system of FIG. 1;

FIG. 4 shows a perspective cutaway view of the system of FIG. 1;

FIG. 5 shows a close-up cross sectional view of the component shown in FIG. 3;

FIG. 6 shows a cross sectional view of the system of FIG. 1, including elements of a wider system;

FIG. 7 shows a schematic cross sectional view of an amplifier suitable for use in a system according to the invention;

FIGS. 8a, 8b, 8c, 8d, 8e, and 8f show six successive stages of an interaction of a shockwave with the amplifier of FIG. 7;

FIG. 9 shows a schematic cross sectional view of a component in accordance with another embodiment of the invention.

### DETAILED DESCRIPTION

Components and systems for exposing fluid to an input shockwave will now be described.

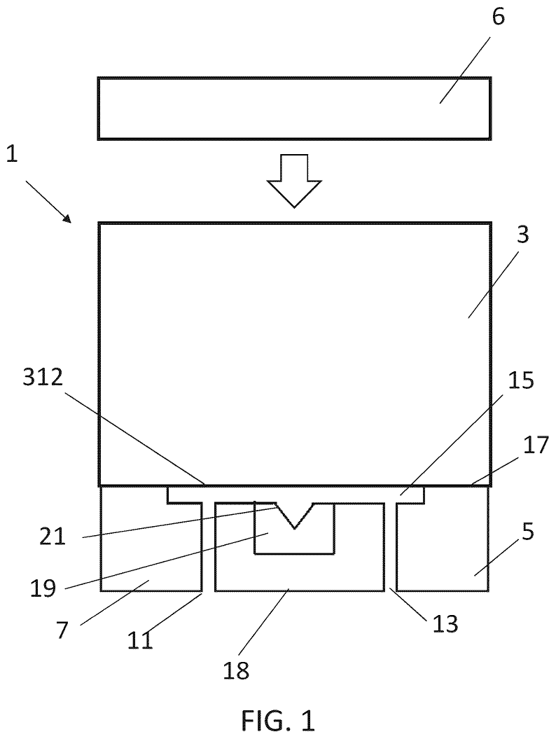

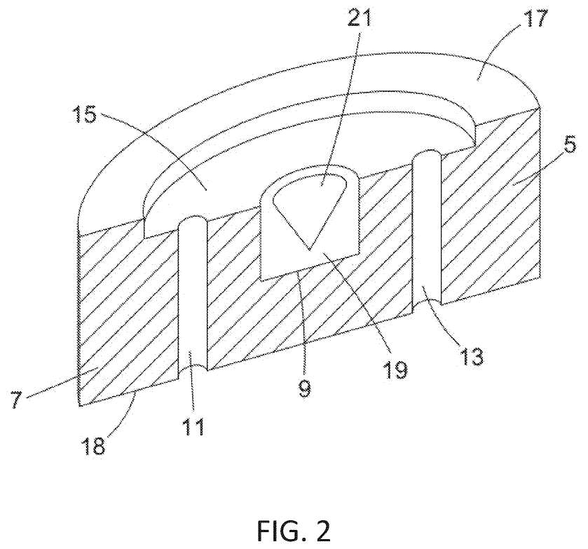

FIG. 1 shows a schematic cross sectional view of a system 1 in accordance with one embodiment of the invention. The system comprises a shockwave modulating element 3 and a component 5 for containing fluid. FIG. 2 shows a perspective cutaway view of the component 5 alone. FIG. 1 also shows a substantially planar projectile 6. In the illustrated embodiment, the projectile 6 is a flat disk, but other projectiles may be used.

The component 5 comprises a body 7. In the illustrated embodiment, the body 7 is approximately cylindrical, but the body 7 may be any suitable and desired shape. The body 7 defines a chamber 21 for containing the fluid, a fluid inlet 11 for introducing fluid into the component 5, a fluid outlet 13 for allowing fluid to leave the component 5, and an intermediate volume 15, a portion of which is defined between the fluid inlet 11 and the fluid outlet 13.

The body 7 has a first surface which is configured to be proximal to the shockwave modulating element 3. This first surface will hereinafter be referred to as the proximal face 17. The body 7 also has a second surface, opposing the proximal face 17. This second surface is configured to be distal from the shockwave modulating element 3. This second surface will hereinafter be referred to as the distal face 18.

In the illustrated embodiment, the intermediate volume 15 is formed as a shallow cylindrical recess in the proximal face 17 of the body 7. The central axis of the intermediate volume 15 is aligned with the central axis of the body 7 itself, both perpendicular to the proximal and distal faces 17, 18. The chamber 21 is formed as a further conical depression within the intermediate volume 15. The maximum diameter of the chamber 21 is smaller than the diameter of the intermediate volume 15. The central axis of the chamber 21 is aligned with the central axes of both the body 7 and the intermediate volume 15.

The chamber 21, which is configured to contain fluid, is formed in a plug 19 that is located in a cylindrical recess 9 in the body 7. Alternatively the chamber 21 could be defined directly in the body 7.

The chamber 21 may be any suitable shape, and in particular may be configured to cooperate with the shockwave modulating element 3 to manipulate the input shockwave.

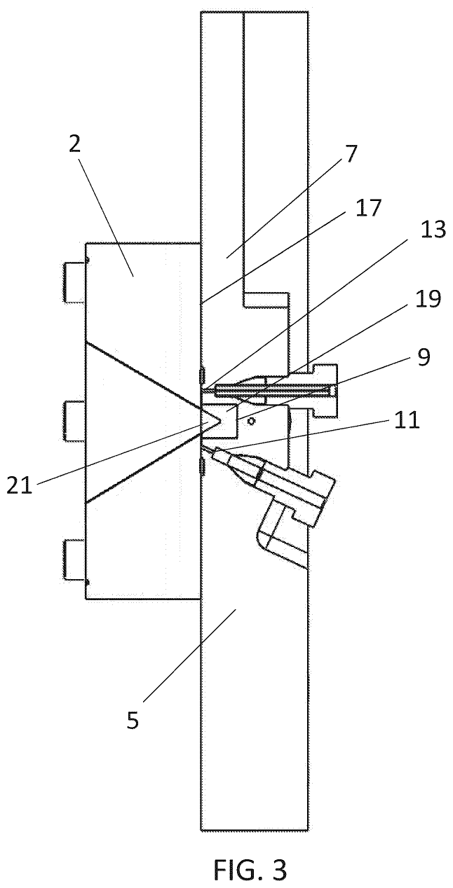

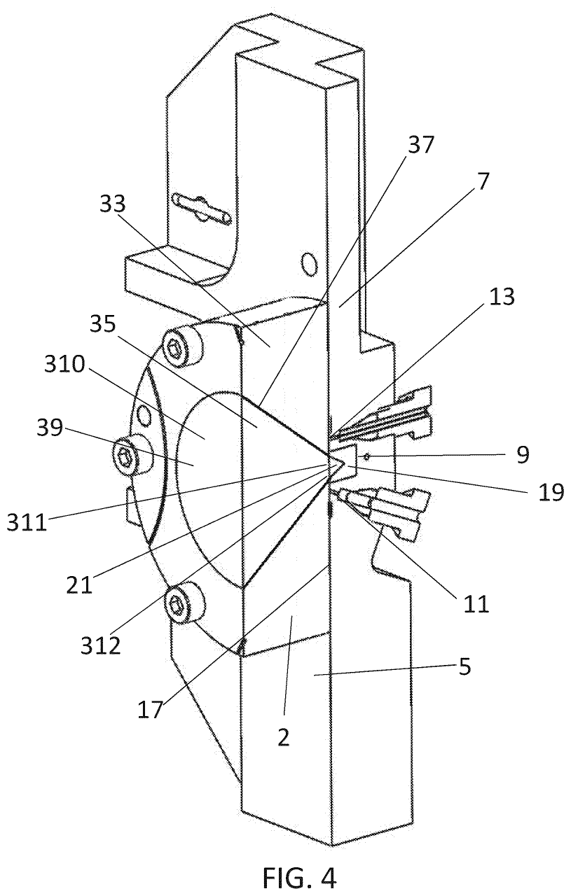

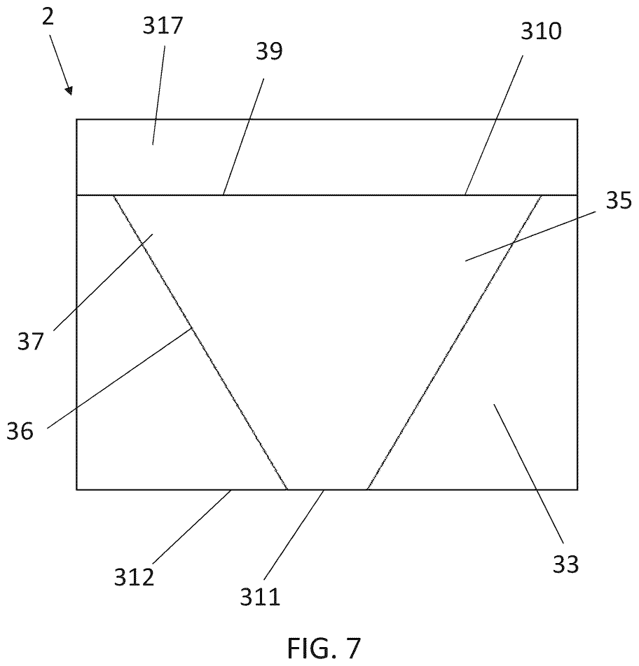

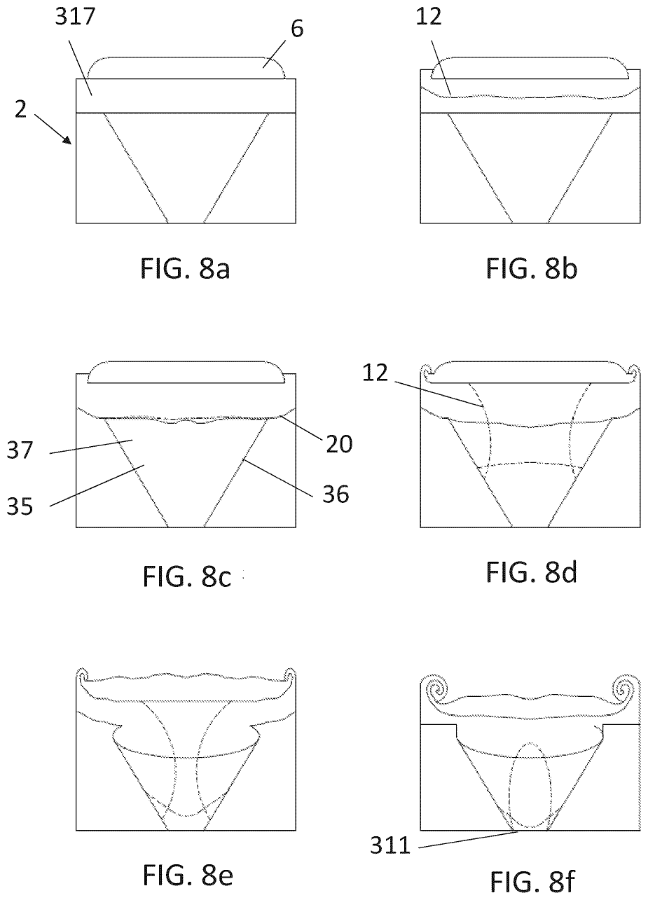

FIGS. 3 to 6 show a system 1 including the component 5 and the shockwave modulating element 3, which is an amplifier 2. The function of the amplifier 2 is explained in further detail below in relation to FIGS. 7 and 8.

An advantage of the plug 19 is that, for example, the shape of the chamber 21 may be configured specifically to work with different shockwave modulating elements, whilst the same shaped body 7 can be used. This plug-and-play configuration increases the overall versatility of the component 5.

The body 7 may be formed from any suitable material since the material from which the body is formed is not an important factor in its function. In the exemplary embodiment illustrated, the body 7 is formed at least partially from steel, although other workable materials such as aluminium or plastics may be used. In the illustrated embodiment, the plug 19 is formed from gold. Gold is used because of its malleability, and so intricate shapes can be manufactured simply, although other materials having similar properties may also be used.

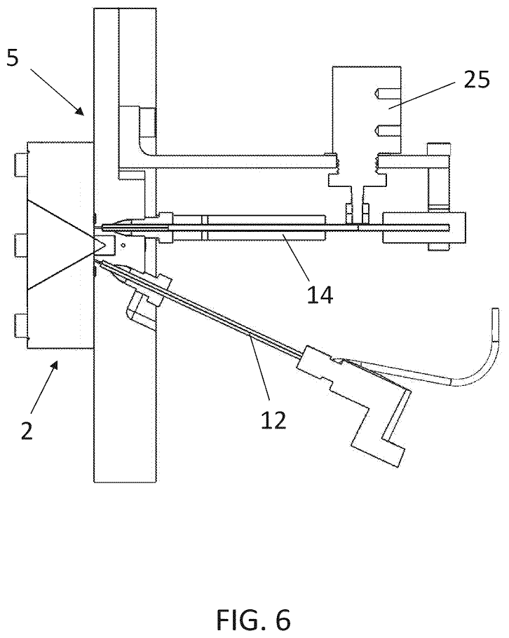

As can be seen from FIG. 6, the fluid inlet 11 and fluid outlet 13 are each connected to inlet and outlet pipes 12, 14. The fluid inlet is connected (via the inlet pipe 12) to a fluid (e.g. fuel) supply. The fluid outlet 13 is connected (via the outlet pipe 14) to a pressure sensor 25. By measuring the pressure at the fluid outlet 13, it can be determined whether or not the fluid has reached the chamber 21 from the fluid inlet 11 since the chamber 21 is located between the fluid inlet 11 and the fluid outlet 13.

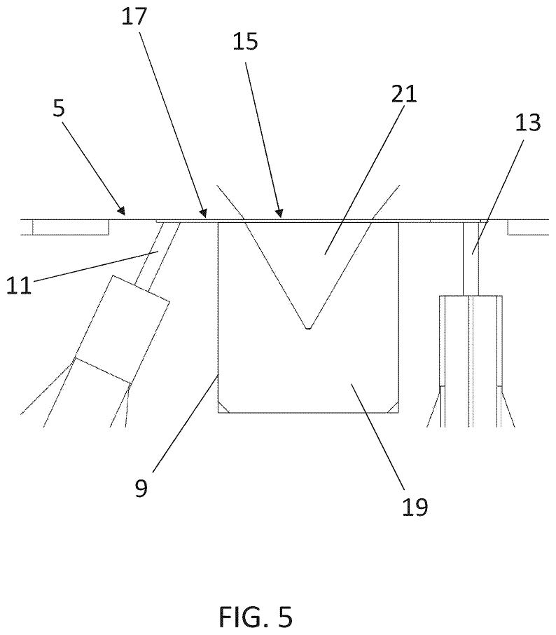

As can be best seen from FIG. 1, and FIG. 5, the intermediate volume 15 is formed as a thin gap defined by a depression or recess in the proximal face 17 of the body 7, and an output face 312 of the amplifier 2. In the illustrated embodiment, the distance between the base of the depression and the output face 312 of the amplifier is between 50 and 100 microns.

FIG. 7 shows a vertical cross section through a shockwave modulating element, which is an amplifier 2. It will be understood that the amplifier 2 shown in FIG. 3 is purely exemplary, and that other amplifier designs may be used in accordance with embodiments of the present invention.

The amplifier 2 comprises a body 33 which defines a hollow frustum shaped cavity 35. The body 33 is formed of a material having a high shock-impedance, such as a heavy metal. In the illustrated embodiment, the body 33 is formed of tantalum, although other materials are suitable, e.g. other heavy metals, such as platinum, copper, steel, or tungsten. The cavity 35 contains a material 37 having a low shock-impedance. The cavity fill material 37 has a lower shock-impedance than that of the body 33. In the illustrated embodiment, the cavity fill material 37 is polymethyl methacrylate (PMMA).

The cavity 35 has an input 39 which is configured to receive a shockwave, and an output 311 which is configured to output the shockwave after the shockwave has propagated through the amplifier 32. The cross sectional area of the input 39 is greater than that of the output 311.

FIG. 7 shows a vertical cross section, and in the illustrated embodiment, the amplifier 2 is rotationally symmetrical. It will therefore be understood that the cavity 35 of the amplifier 2 is shaped as a conic frustum with an input radius greater than the output radius. The amplifier 2 has an input face 310 which is proximal to the input 39 of the cavity 35, and an output face 312 which is proximal to the output 311 of the cavity 35.

FIG. 7 shows an embodiment of the amplifier 2 having an impedance matching layer 317 provided on the input face 310 of the amplifier 2. The impedance matching layer 317 is a planar layer of material having a shock-impedance which is between that of the projectile 6, and that of the cavity fill material 37. The impedance matching layer 317 improves the coupling efficiency into the amplifier 2 such that a higher proportion of the energy input into the amplifier 2 by the projectile 6 is transmitted into the cavity fill material 37.

The function of the amplifier 2 will now be further explained with reference to FIGS. 8a-e. FIGS. 8a-e show a projectile 6 striking the amplifier 2 shown in FIG. 8a. FIG. 8a shows the projectile 6 striking the impedance matching layer 317. At FIGS. 8b, and 8c, a resulting shockwave 12 passes through the impedance matching layer 317, and enters the cavity fill material 37. Pressures are increased in the amplifier 2 through shockwave reflection and superposition within the cavity 35.

On input into the cavity 35, the incident shock reflects from the cavity walls 36, as seen in FIG. 8d, as an irregular shock reflection (Mach reflection), that propagates in from the cavity walls 36, eventually overlapping on the central axis of the cavity 35 as shown in FIG. 8e and FIG. 8f.

The overlap of this radially-symmetric wave on the central axis creates a high pressure point within the cavity fill material 37, which expands and interacts with the impinging Mach reflection, leading to the generation of an axial, quasi-planar Mach stem that propagates towards the output 311 of the cavity 35. This wave eventually reaches the output 311 of the cavity 35 and emerges from the amplifier 2 with a higher pressure than that of the original input shockwave 12.

Referring again to FIGS. 3 to 6, as the shockwave exits the output 311 of the cavity 35, it is directed into the chamber 21 where the fluid is contained. The fluid may be a fusionable fuel such as deuterium gas. If a sufficiently high pressure is input from the cavity 35 to the chamber 21, the fluid will collapse, resulting in intense pressures and temperatures being generated in the collapsed fluid, which may be sufficient to initiate fusion.

By inputting the fluid into the chamber 21 via the intermediate volume 15, rather than providing the fluid inlet 11 directly into the chamber 21, the dynamics of the collapse of the fluid are not affected by an inlet tube. The collapse is therefore more efficient, which may generate pressure and temperatures that are sufficient to initiate fusion or potentially lead to a higher fusion yield.

Although the chamber 21 is not sealed off from the fluid inlet 11 or fluid outlet 13, the speed of collapse is so great that collapse occurs faster than the fluid would be able to escape into the fluid inlet 11 and fluid outlet 13.

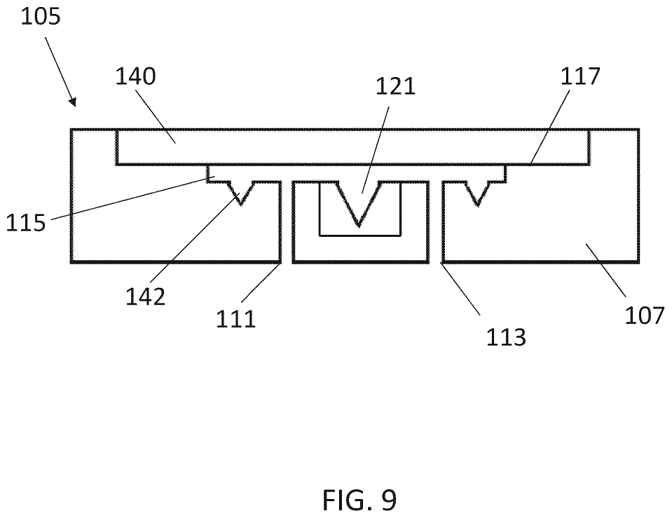

FIG. 9 shows a cross sectional view of a component 105 according to a further embodiment. The component 105 is configured to be used without a further element, such as a shockwave modulating element. For this reason, the component 105 comprises a cover slip 140 provided on its proximal face 117 in order to close the intermediate volume 115. As such, the intermediate volume is defined by the depression in the proximal face 117 of the body 107, and the cover slip 140.

In the illustrated embodiment, the cover slip 140 is glued to the body 107. Since it would be problematic if excess glue were to flow into the fluid inlet 111, fluid outlet 113, or the chamber 121, a glue channel 142 is provided between the outer wall of the depression defining the intermediate volume, and the fluid inlet 111 and fluid outlet 113. Although FIG. 9 appears to show two glue channels, it will be understood that this is because FIG. 9 shows a cross sectional view, and since the component (other than the fluid inlet 11 and fluid outlet 13) is rotationally symmetrical, the glue channel 142 is annular. In other embodiments, the cover slip 140 and body 107 may be clamped together, removing the need for an adhesive. In such embodiments, a sealing member such as an O-ring may be clamped between the cover slip 140 and the body 107 in order to provide an acceptable seal. Since no glue is present in such embodiments, the glue channel 142 may be omitted. The cover slip may be made of any suitable material, for example, glass.

Although the embodiments described herein each contain only a single chamber for containing fluid, it is envisaged that a component may be provided which feeds a plurality of chambers from a single inlet, and a single intermediate volume.

1. A component for exposing fluid to an input shockwave, the component comprising:
a body defining:
an input face arranged to receive the input shockwave;
a chamber recessed in the input face for containing fluid;
a fluid inlet for introducing fluid into the component; and
an intermediate volume defined in the input face;
wherein the intermediate volume is provided at least partially between the fluid inlet and the chamber;
wherein the intermediate volume is fluidly connected to the fluid inlet and to the chamber for supplying fluid from the fluid inlet to the chamber; and
wherein a portion of the input face is configured to sealingly abut against a further element for enclosing the intermediate volume.

2. The component as claimed in claim 1, wherein the body defines a fluid outlet for outputting fluid from the component, wherein the fluid outlet is fluidly connected to the intermediate volume.

3. The component as claimed in claim 1, wherein the body comprises a plug, wherein the plug defines the chamber.

4. The component as claimed in claim 3, wherein the plug is formed from a soft metal, e.g. gold.

5. The component as claimed in claim 1, wherein the chamber is conical.

6. The component as claimed in claim 1, wherein the input face is configured to sealingly abut against a shockwave modulating element.

7. The component as claimed in claim 1, wherein the component comprises the further element for enclosing the intermediate volume.

8. The component as claimed in claim 7, wherein the further element is at least partially affixed to the body by an adhesive.

9. The component as claimed in claim 8, wherein the body defines one or more channels in the intermediate volume, wherein the one or more channels are configured to substantially prevent excess adhesive from reaching the chamber and/or the fluid inlet.

10. A component for exposing fluid to an input shockwave, the component comprising:
an element configured to receive the input shockwave and allow the shockwave to propagate through the element; and
a body defining:
an input face arranged to at least partially receive the shockwave after it has propagated through the element;
a chamber defined in the input face for containing fluid;
a fluid inlet for introducing fluid into the component; and
an intermediate volume defined in the input face;
wherein the intermediate volume is provided at least partially between the fluid inlet and the chamber;
wherein the intermediate volume is fluidly connected to the fluid inlet and to the chamber for supplying fluid from the fluid inlet to the chamber; and
wherein the input face is configured to sealingly abut against the element such that the intermediate volume is enclosed by the element.

11. The component as claimed in claim 10, wherein the element is a shockwave modulating element, wherein the shockwave modulating element is arranged to receive an input shockwave and manipulate the input shockwave so to produce a manipulated shockwave.

12. The component as claimed in claim 1, wherein the element comprises:
an element body comprising a first material;
wherein the element body defines a cavity for manipulating the input shockwave so to produce a manipulated shockwave;
wherein the cavity comprises:
an input for receiving the input shockwave incident upon the component; and
an output for outputting the manipulated shockwave from the cavity; and
wherein the cavity contains a second material having a shock-impedance that is lower than a shock-impedance of the first material.

13. The component as claimed in claim 12, wherein the body is shaped such that a cross sectional area of the input is greater than a cross sectional area of the output.

14. A method of manipulating a shockwave, the method comprising generating at least one shockwave to be incident upon a component, the component comprising:
a body defining:
an input face arranged to receive the input shockwave;
a chamber recessed in the input face for containing fluid;
a fluid inlet for introducing fluid into the component; and
an intermediate volume defined in the input face;
wherein the intermediate volume is provided at least partially between the fluid inlet and the chamber;
wherein the intermediate volume is fluidly connected to the fluid inlet and to the chamber for supplying fluid from the fluid inlet to the chamber; and
wherein a portion of the input face is configured to sealingly abut against a further element for enclosing the intermediate volume.

15. The method as claimed in claim 14, comprising driving a projectile into the component to generate the at least one shockwave.

16. The component as claimed in claim 1, wherein the component is for exposing fluid fusionable fuel to an input shockwave.

17. The component as claimed in claim 1, wherein the component is configured to hold the fluid in the chamber such that the fluid can be exposed to a high-pressure shockwave.

18. The method as claimed in claim 14, further comprising:
supplying fluid from the fluid inlet to the chamber via the intermediate volume;
holding the fluid in the chamber such that the fluid can be exposed to a shockwave;
generating at least one shockwave to be incident upon the input face of the component; and
receiving the shockwave at the input face of the component.
